(19) United States
(12) Patent Application Publication
(10) Pub. No.: US 2009/0092031 A1
(43) Pub. Date: Apr. 9, 2009

(54) OPTICAL PICKUP MODULE AND MANUFACTURING METHOD THEREOF

(76) Inventors: Ki-Chang SONG, Anyang (KR); Geun-Ho KIM, Seoul (KR); Sun-Ho KIM, Seoul (KR)

Correspondence Address: BIRCH STEWART KOLASCH & BIRCH, PO BOX 747, FALLS CHURCH, VA, 22040-0747, US

(21) Appl. No.: 12/330,445

(22) Filed: Dec. 8, 2008

Related U.S. Application Data
(62) Division of application No. 10/980,784, filed on Nov. 4, 2004.

(30) Foreign Application Priority Data
Nov. 5, 2003 (KR) 78038/2003

(51) Int. Cl. G11B 7/00

(52) U.S. Cl. 369/120

(57) ABSTRACT

Disclosed are an optical pickup module and a manufacturing method thereof. The manufacturing method of an optical pickup module includes: forming a wet-etching mask layer at an outer portion of an upper surface of a silicon substrate to be used as a sub mount; etching a middle portion of the silicon substrate by using the wet-etching mask layer thereby forming a cavity, forming an inclination surface at the etched portion, and then removing the wet-etching mask layer; forming an insulating layer on an entire upper surface of the to silicon substrate; forming an electrode layer on an upper surface of the insulating layer; forming adhesive layers at a part of an upper surface of the electrode layer; and arranging a light emitting device at an upper surface of one adhesive layer and arranging an MPD at an upper surface of another adhesive layer by a fixation thereby completing an optical pickup module.

This application is a Divisional of co-pending application Ser. No. 10/980,784 filed on Nov. 4, 2004 and for which priority is claimed under 35 U.S.C. § 120. This application claims priority to Application No. 2003/78038 filed in Korea on Nov. 5, 2003 under 35 U.S.C. § 119. The entire contents of each of the above-identified applications are hereby incorporated by reference.

### BACKGROUND OF THE INVENTION

1. Field of the Invention

The present invention relates to an optical pickup module and a manufacturing method thereof, and more particularly, to an optical pickup module capable of enhancing an optical precision and reducing a manufacturing cost by forming a reflector at a sub mount and by forming a light emitting device and a multi-divide photodiode at the sub mount together, and a manufacturing method thereof.

2. Description of the Conventional Art

Generally, a light emitting device was used as a display device using luminescence. However, recently, the light emitting device is much being used as an optical source for emitting various wavelengths and energy. The currently used light emitting device is largely divided into a laser diode (LD) and a light emitting diode (LED). The LD is widely used as an optical source in an optical communication field, and is recently used as an important component not only in a field of a compact disc (CD) recording apparatus and a compact disc recording/reproducing apparatus (CD-RW) but also in an optical media field such as a DVD reproducing apparatus, a laser disc (LD) reproducing apparatus, a minimum disc (MD) reproducing apparatus, etc.

The LED is being applied not only to a general display device but also to a backlight device of lighting equipment or an LCD display device.

As the optical media system is being widely used, an optical pickup module, a core component of the optical media system is considered to be important. An optical media device using a laser diode, a light emitting device as an optical source for reproducing data stored by a digital storage method into a non-contact method, for example, a CD, a CD-RW, a DVD, an LD, or an MD has an excellent media quality and can fast reproduce data at an arbitrary position. According to this, even if the optical media system is more expensive than the conventional analogue system, it is being used more and more.

FIG. 1 is a construction view schematically showing an optical pickup device applied to an optical media system in accordance with the conventional art.

As shown, the conventional optical pickup device comprises: an optical device package 40, a laser optical source; a collimator 5; a beam splitter 4; a reflector 3; an objective lens 2; an optical disc 1; a focusing lens 6; and a multi-divide photodiode (MPD) 7.

An operation of the conventional optical pickup device will be explained as follows. First, laser beam emitted from the optical device package 40 is converted into parallel light by the collimator 5, and the parallel light passes through the beam splitter 4 thus to be reflected by the reflector 3. The reflected light passes through the objective lens 2, and then is focused into the optical disc 1.

The laser beam focused into the disc 1 is reflected from the disc 1 thus to pass through the objective lens 2 and the reflector 3 sequentially. Then, some of the laser beam progresses towards the optical device package 40 and the rest of the laser beam progresses towards the multi-divide photodiode 7.

The laser beam towards the multi-divide photodiode 7 is focused into the multi-divide photodiode 7 by the focusing lens 6. At this time, a voltage is generated, and the generate voltage causes a servo signal. The servo signal is transmitted to a tracking actuator (not shown) and a focus actuator (not shown) attached to the objective lens 2, and the tracking actuator and the focus actuator drive the objective lens 2 in a horizontal direction and in a vertical direction thereby to perform a focus servo operation and a tracking servo operation. By the focus servo operation, a signal surface of the optical disc is precisely positioned in a depth of laser beam. Also, by the tracking servo operation, the objective lens moves along a concentricity of the optical disc and converts information recorded in the disc 1 into an electric signal thereby to obtain a precise information data.

In the conventional optical pickup device, one of the most important technique is a precise operation of the optical device package 40.

That is, a strength of laser beam generated from the optical device package is detected and then is fed back so that the optical device package can always provide uniform laser beam and thereby information of the disc can be precisely read.

FIG. 2 is a section view showing an optical pickup module in accordance with the conventional art, and FIG. 3 is a section view showing an optical device package in accordance with the conventional art.

As shown in FIG. 2, the optical pickup module 50 includes: a sub mount 20 composed of a silicon substrate 21 and an insulating layer 22; an LD 10 formed at an upper surface of the sub mount 20 and emitting laser beam; and a heat emitting plate 30.

When a voltage is applied to the LD 10, light and heat are generated. In case that the generated heat is accumulated in the LD 10, the LD is deteriorated and a lifespan thereof is shortened. In order to prevent the problems, the LD 10 is supported at the sub mount 20 and the sub mount 20 is mounted at the heat emitting plate 30. The mounting structure is called as an optical pickup module.

As shown in FIG. 3, in the optical device package 40, an optical pickup module 50 is fixed to an inner surface of a stem 41, and an MPD 47 is arranged at an inner surface of the stem 41 through which light backwardly emitted from the LD 10 passes.

A plurality of external electrodes 42 and 42a are penetratingly formed at the stem 41. One end of the external electrode 42 is connected to an electrode (not shown) of the LD 10 through a metal wire 43; and one end of the external electrode 42a is connected to an electrode of the MPD 47 through a metal wire 43a. A current or a voltage flowing through the electrodes 42 and 42a is respectively supplied to the electrodes of the LD 10 and the MPD 47 through the metal wires 43 and 43a.

One surface of the stem 41 is covered by a cap 44 thereby to form a vacuum portion 41a therein, and a lens 45 is installed at a front surface of the cap 44.

However, in the optical device package, only the LD 10 has to be formed at the sub mount 20, and the MPD 47 has to be arranged to be aligned with the LD 10 in an additional process, more specifically, the MPD 47 has to be positioned at the inner surface of the stem 41 where light backwardly emitted from the LD 10 passes. According to this, a manufacturing process is very complicated.

Also, the process for connecting each electrode of the MPD and LD to the external electrode is very complicated, an optical precision is low due to an alignment error, and an entire volume is increased.

### SUMMARY OF THE INVENTION

Therefore, an object of the present invention is to provide an optical pickup module capable of enhancing an optical precision and reducing a manufacture cost by forming a reflector by partially removing a sub mount and by forming a laser diode and a multi-divide photodiode at the sub mount together, and a manufacturing method thereof.

To achieve these and other advantages and in accordance with the purpose of the present invention, as embodied and broadly described herein, there is provided an optical pickup module comprising: a sub mount having a reflector formed as an upper portion thereof is partially removed by an etching, and having an electrode at an upper surface thereof; a light emitting device arranged at one side of the upper surface of the sub mount so that light backwardly emitted therefrom can be towards the reflector; and a multi-divide photodiode arranged at another side of the upper surface of the sub mount and placed at a position where light backwardly emitted from the light emitting device and reflected by the reflector passes.

The sub mount is composed of: a silicon substrate partially etched as much as an acute angle, i.e. an angle of 40°-60°; an insulating layer formed at an upper portion of the silicon substrate; a reflector formed on the insulating layer of the region etched as much as an angle of 40°-60°; and electrodes for being electrically connected with the light emitting device and the multi-divide photodiode.

To achieve these and other advantages and in accordance with the purpose of the present invention, as embodied and broadly described herein, there is also provided a manufacturing method of an optical pickup module comprising the steps of forming a wet-etching mask layer at an outer portion of an upper surface of a silicon substrate to be used as a sub mount; etching a middle portion of the silicon substrate by using the wet-etching mask layer thereby forming a cavity, forming an inclination surface of 40°-60° at the etched portion, and then removing the wet-etching mask layer; forming an insulating layer on an entire upper surface of the silicon substrate; forming an electrode layer on an upper surface of the insulating layer; forming adhesive layers at a part of an upper surface of the electrode layer; and arranging a light emitting device at an upper surface of one adhesive layer and arranging an MPD at an upper surface of another adhesive layer by a fixation thereby completing an optical pickup module.

According to another embodiment of the present invention, there is provided a manufacturing method of an optical pickup module comprising the steps of: forming a first wet-etching mask layer on a silicon substrate to be used as a sub mount by using a chemical vapor deposition method; etching an end of the silicon substrate thereby forming a bench, and then removing the first wet-etching mask layer; forming a second mask layer at an outer portion of an upper surface of the silicon substrate, then etching the upper surface of the silicon substrate thereby forming a cavity and an inclination surface of 40°-60° at the etched portion, and then removing the second mask layer; forming an insulating layer on the entire upper surface of the silicon substrate; forming an electrode layer on an upper surface of the insulating layer; forming adhesive layers at a part of an upper surface of the electrode layer; and arranging a light emitting device at an upper surface of one adhesive layer and arranging an MPD at an upper surface of another adhesive layer thereby completing an optical pickup module.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a construction view schematically showing an optical pickup device in accordance with the conventional art;

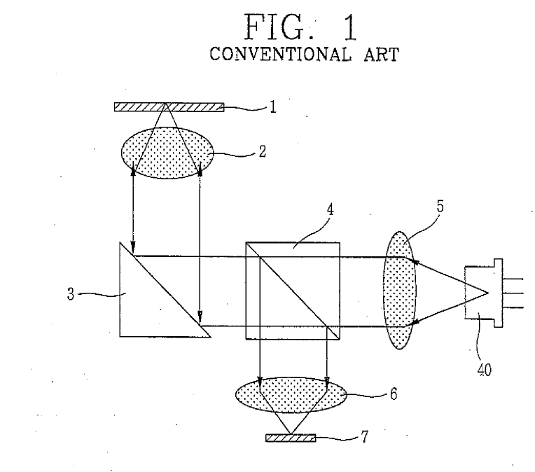

FIG. 2 is a longitudinal section view showing an optical pickup module in accordance with the conventional art;

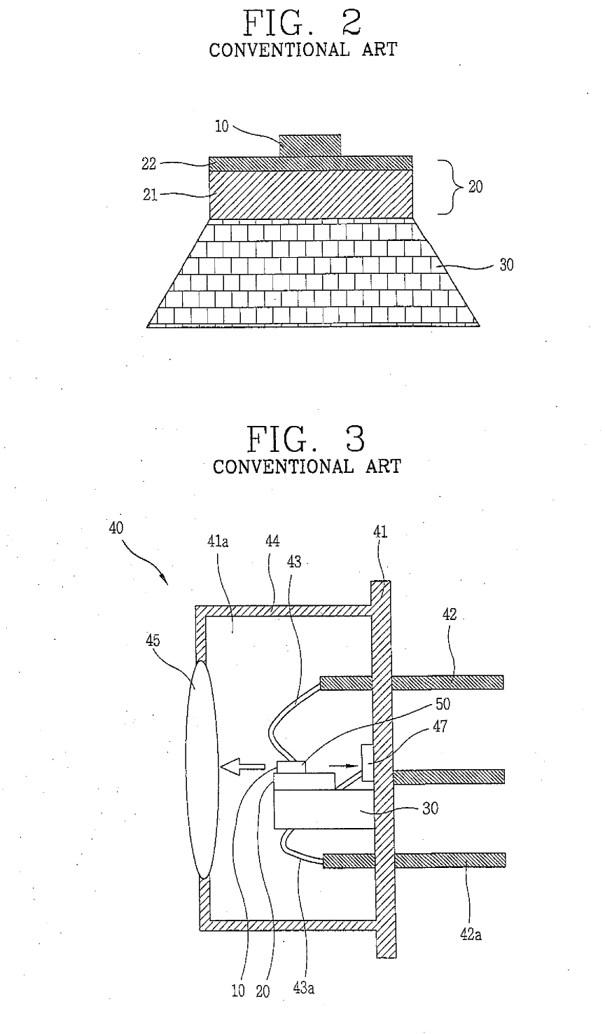

FIG. 3 is a longitudinal section view showing an optical device package in accordance with the conventional art;

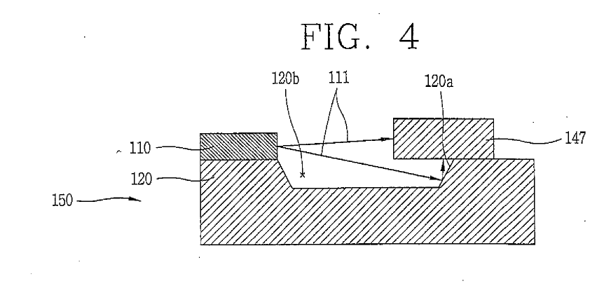

FIG. 4 is a longitudinal section view showing an optical pickup module according to one embodiment of the present invention;

FIGS. 5A to 5F are flow charts showing a manufacturing method of the optical pickup module according to one embodiment of the present invention;

FIG. 6 is a longitudinal section view showing an optical pickup module according to another embodiment of the present invention;

FIGS. 7A to 7G are flow charts showing a manufacturing method of the optical pickup module according to another embodiment of the present invention; and

FIG. 8 is a longitudinal section view showing an optical device package to which the optical pickup module of the present invention is applied.

### DETAILED DESCRIPTION OF THE PREFERRED EMBODIMENTS

Reference will now be made in detail to the preferred embodiments of the present invention, examples of which are illustrated in the accompanying drawings.

Hereinafter, an optical pickup module and a manufacturing method thereof according to the present invention will be explained with reference to the attached drawings as follows.

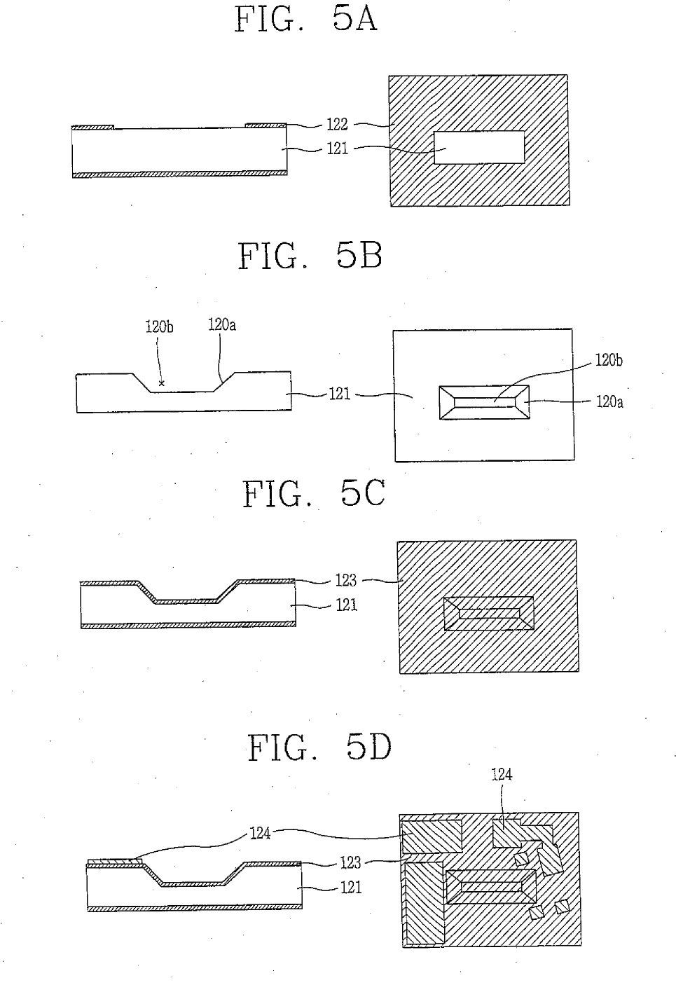

FIG. 4 is a longitudinal section view showing an optical pickup module according to one embodiment of the present invention.

As shown, in an optical pickup module 150 according to one embodiment of the present invention, a reflector 120a formed by etching a part of a sub mount 120 is placed in the middle portion of the sub mount 120. Also, a light emitting device 110 is arranged at one side of an upper surface of the sub mount 120, and an MPD 147 is arranged at another side of the upper surface of the sub mount 120. The MPD 147 is positioned at a portion where light backwardly emitted from the light emitting device 110 directly passes or passes through the reflector 120a.

That is, in the optical pickup module 150 according to one embodiment of the present invention, the middle portion of the sub mount 120 is etched and a cavity or path 120b through which light 111 backwardly emitted from the light emitting device 110 passes is formed at the etched portion. Then, the reflector 120a is formed, so that the light 111 backwardly emitted from the light emitting device 110 can effectively reach the MPD 147. Also, the light emitting device 110 for emitting laser beam, and the MPD 47 for detecting the light 111 backwardly emitted from the light emitting device 110 are together formed at the sub mount 120.

The sub mount 120 is composed of a silicon substrate (not shown) and an insulating layer (not shown), and the insulating layer is preferably formed of an insulating material having a high heat transfer coefficient. The reflector 120a can be formed by depositing Ag having a high reflection rate at an inclination surface of 40°-60°. Also, an inclination surface of 40°-60° formed at the silicon substrate can be used as the reflector 120a by using a reflection characteristic of the silicon substrate.

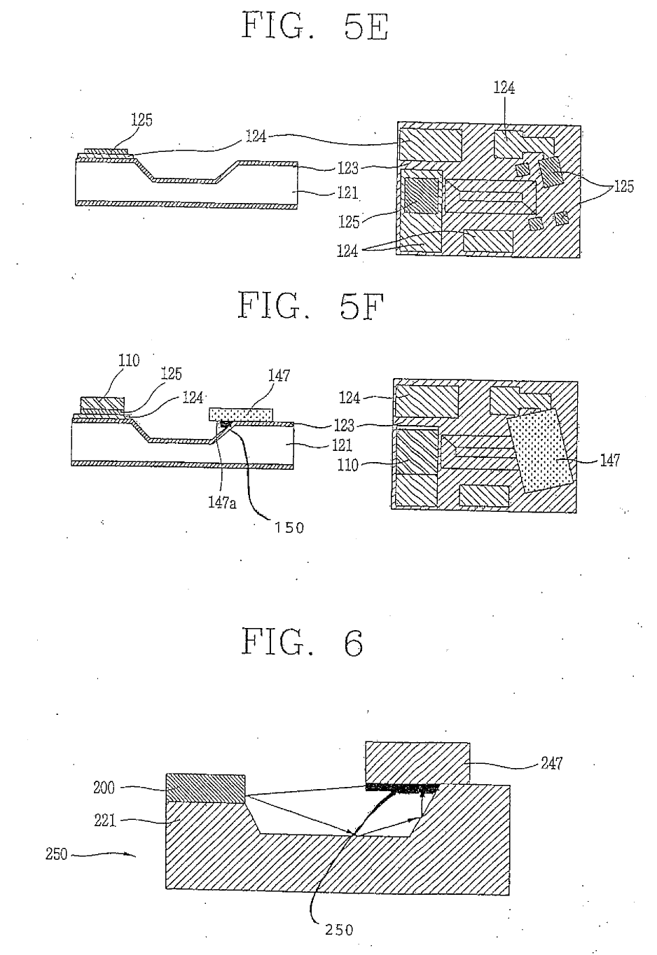

Hereinafter, a manufacturing method of the optical pickup module according to one embodiment of the present invention will be explained with reference to FIGS. 5A to 5F.

FIGS. 5A to 5F are flow charts showing a manufacturing method of the optical pickup module according to one embodiment of the present invention, in which the right drawings are plane views showing each component of the optical pickup module and the left drawings are longitudinal section views showing each component of the optical pickup module.

As shown in FIG. 5A, a wet-etching mask layer 122 is formed at an outer portion of an upper surface of a silicon substrate to be used as a sub mount by using a chemical vapor deposition method.

Then, as shown in FIG. 5B, a middle portion of the silicon substrate 121 is etched by using the wet-etching mask layer 122 of FIG. 5A thereby to form a cavity 120b and an inclination surface of 40°-60° 120a. Then, the wet-etching mask layer 122 of FIG. 5A is removed.

As shown in FIG. 5C, an insulating layer 123 is formed on an entire upper surface of the silicon substrate 121. The insulating layer can be formed of AIN, ZnO or BeO having a high heat transfer coefficient by a sputtering method or a deposition method, or can be formed of a silicon nitride or a silicon oxide.

The reflector can be formed by depositing a metal having a high reflection rate such as Ag at the inclination surface of 40°-60° 120a. Also, the insulating layer 123 can be used as the reflector by using a reflection characteristic thereof.

As shown in FIG. 5D, an electrode layer 124 is formed at an upper surface of the insulating layer 123 by using a lift-off method. The electrode layer 124 serves as an electrode for applying a voltage to an LD and an MPD to be manufactured in a later process.

As shown in FIG. 5E, an adhesive layer 125 is formed of a material such as a solder, a conductive epoxy, etc. at a part of the upper surface of the electrode layer 124.

As shown in FIG. 5F, a light emitting device 110 is arranged at an upper surface of the adhesive layer 125, and an MPD 147 is arranged at the adhesive layer 125 thus to be fixed. The light emitting device 110 is arranged so that light backwardly emitted therefrom progresses towards the MPD 147 and the reflector 120a.

The MPD 147 directly receives light backwardly emitted from the light emitting device 110 or receives by the reflector 120a, thereby converting an output of the light emitting device 110 into an electric signal and thus providing the 10, electric signal to an external control circuit. According to this, the output of the light emitting device 110 can be always constantly maintained.

By the above processes, the reflector 120a can be formed at the sub mount 120, and the light emitting device 110 and the MPD 147 can be together formed with the same height.

The MPD 147 is arranged at a portion where light backwardly emitted from the light emitting device 110 passes. The MPD 147 is formed as a rectangular hexahedron shape, and a sensing unit (not shown) for sensing light backwardly emitted from the light emitting device 110 is formed at a bottom surface 147a having a relatively wide area among several surfaces of the MPD 147 thereby to enhance an optical precision.

As aforementioned, in the optical pickup module according to one embodiment of the present invention, the light emitting device 110 is arranged at the upper surface of the adhesive layer 125, and the MPD 147 is arranged on the adhesive layer 125, that is, the light emitting device 110 and the MPD 147 are together formed on the same plane of the sub mount. According to this, the process for electrically connecting the electrodes of the LD and the MPD to external electrodes is very simplified and thus a necessary physical space is decreased, thereby greatly reducing a size of the optical device package.

In the manufacturing method of the optical pickup module according to one embodiment of the present invention, the process for forming the light emitting device 110 and the MPD 147 at the sub mount with the same height was explained.

Hereinafter, will be explained a process for forming a light emitting device 210 and a MPD 247 together at the sub mount in a condition that the height of the light emitting device is relatively lower than the height of the MPD in order to effectively transmit light backwardly emitted from the light emitting device 210 to a sensing unit formed at the lower surface of the MPD 247.

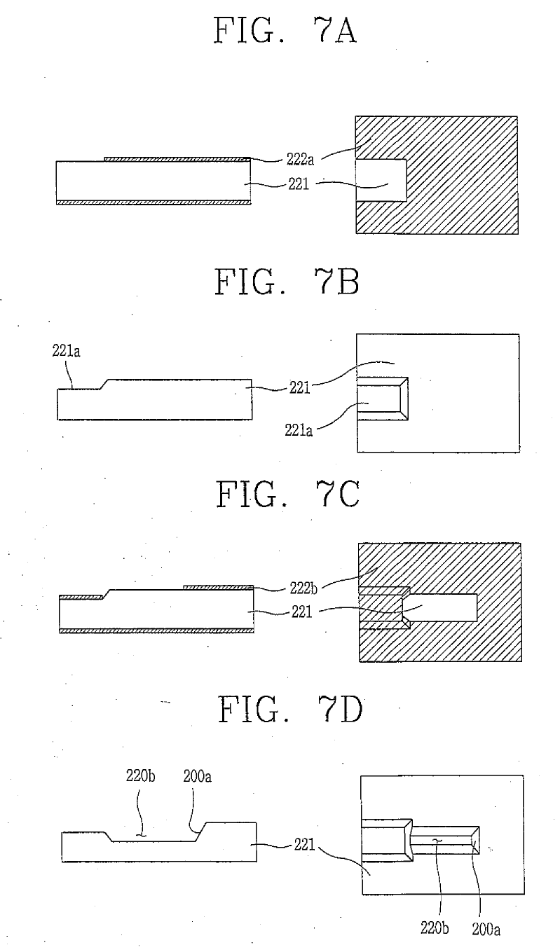

FIG. 6 is a longitudinal section view showing an optical pickup module according to another embodiment of the present invention.

As shown, in an optical pickup module 250 according to another embodiment of the present invention, an LD 210 is formed at the sub mount at a lower position than an MPD 247. Under the structure, light backwardly emitted from the LD fast reaches a sensing unit (not shown) of the MPD 247 directly or through a reflector, thereby more enhancing an optical precision.

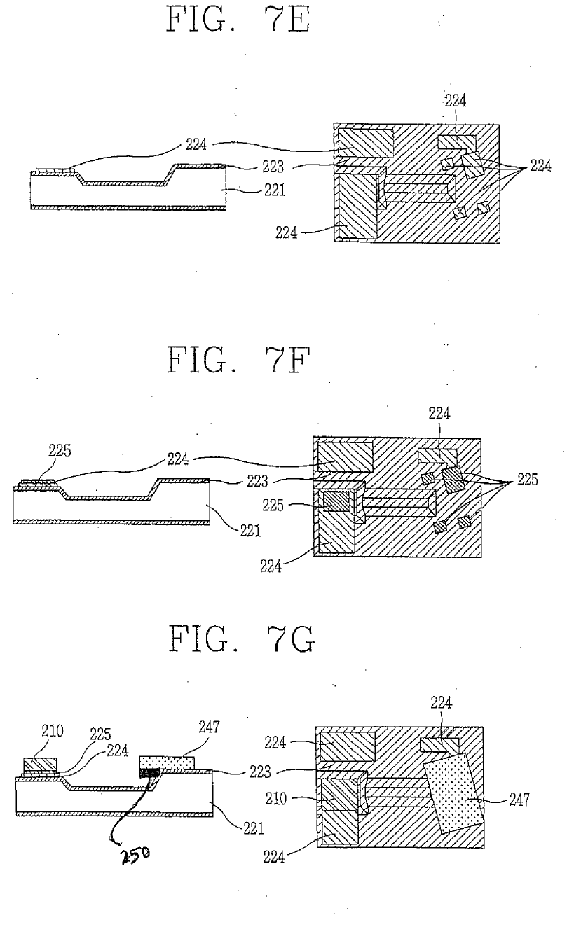

FIGS. 7A to 7G are flow charts showing a manufacturing method of the optical pickup module according to another embodiment of the present invention, in which the right drawings are plane views showing each component of the optical pickup module and the left drawings are longitudinal section views showing each component of the optical pickup module.

As shown in FIG. 7A, a first wet-etching mask layer 222a is formed at a silicon substrate 221 to be used as a sub mount by using a chemical vapor deposition method, etc.

Then, as shown in FIG. 7B, an end portion of the silicon substrate 221 is etched by using the first wet-etching mask layer 222a of FIG. 7A thereby to form a bench 221a. Then, the first wet-etching mask layer 222a of FIG. 7A is removed.

As shown in FIG. 7C, a second mask layer 222b is formed at an outer portion of an upper portion of the silicon substrate 221. Then, as shown in FIG. 7D, the upper surface of the silicon substrate 221 is removed thereby to form a cavity 220b and an inclination surface of 400-60.degree. 220a at the etched portion. Then, the second mask layer 222b of FIG. 7D is removed.

As shown in FIG. 7E, an insulating layer 223 is formed on an entire upper surface of the silicon substrate 221. The insulating layer 223 can be formed of AIN, ZnO or BeO having a high heat transfer coefficient by a sputtering method or a deposition method, or can be formed of a silicon nitride or a silicon oxide.

The reflector can be formed by depositing a metal having a high reflection rate such as Ag at the inclination surface of 40°-60°. 220a. Also, the insulating layer 223 can be used as the reflector by using a reflection characteristic thereof. Then, an electrode layer 224 is formed at an upper surface of the insulating layer 223 by using a lift-off method. The electrode layer 224 serves as an electrode for applying a voltage to an LD and an MPD to be manufactured in a later process.

As shown in FIG. 7F, an adhesive layer 225 is formed of a material such as a solder, a conductive epoxy, etc. at a part of the upper surface of the electrode layer 224.

As shown in FIG. 7G, a light emitting device 210 is arranged at an upper surface of the left adhesive layer 225, and an MPD 247 is arranged at an upper surface of the right adhesive layer 225 thus to be fixed. The light emitting device 210 is arranged so that light backwardly emitted therefrom can progress towards the MPD 247 and the reflector formed at the sub mount 221. The MPD 247 directly receives light backwardly emitted from the light emitting device 210 or receives by the reflector, thereby converting an output of the light emitting device 210 into an electric signal and thus providing the electric signal to an external control circuit. According to this, the output of the light emitting device 210 can be always constantly maintained. By the above processes, the reflector can be formed at the sub mount 221, and the light emitting device 210 and the MPD 247 can be together formed at the sub mount.

The MPD 247 is arranged at a portion where light backwardly emitted from the light emitting device 210 passes. Also, the light emitting device 210 is arranged at a bench 221a of FIG. 7B thus to be formed at a portion lower than the MPD 247 positioned at the upper portion of the reflector. According to this, light backwardly emitted from the light emitting device 210 can be incident on the MPD 247 more effectively through the reflector thereby to enhance an optical precision.

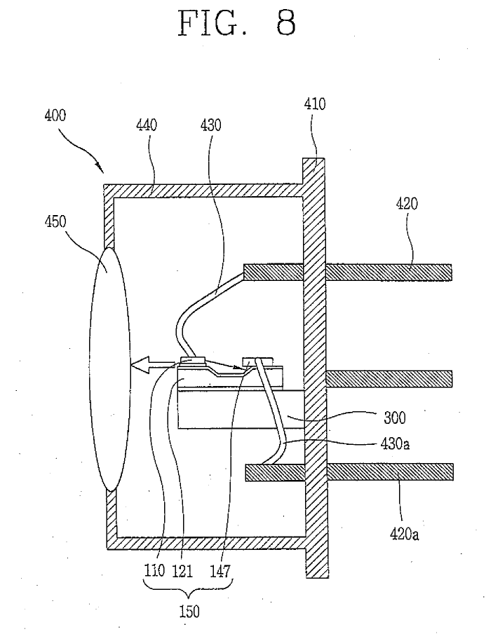

FIG. 8 is a longitudinal section view showing an optical device package to which the optical pickup module of the present invention is applied.

As shown, in an optical device package 400 of the present invention, an optical pickup module 150 is arranged at a stem 410, and the light emitting device 110 and the MPD 147 are respectively connected to electrodes 420 and 420a of the optical package through metal wires 430 and 430a on the same plane of the sub mount. A cap 440 covers a lateral surface of the stem 410 so as to cover the light emitting device 110, the MPD 147, and the electrode 420.

In the optical device package according to the present invention, differently from the conventional art, only the light emitting device 110 is arranged at a lens 450. According to this, every connection among components is possible at a single position without changing a position at the time of an electric connection process, and thereby processes and a volume of the optical device package can be greatly reduced.

As aforementioned, in the optical pickup module and the manufacturing method thereof, the reflector is formed by partially removing the inside of the sub mount, and the light emitting device and the MPD are together formed at the sub mount thereby to enhance an optical precision of the light emitting device and the MPD. Also, by closely maintaining the distance between the light emitting device and the MPD, a light emitting characteristic of the light emitting device can be stably maintained and the optical pickup module can be minimized. Also, since the electrodes of the light emitting device and the MPD are very simply connected to external electrodes, a yield can be enhanced and a manufacture cost can be greatly reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An optical pickup module comprising:
a sub mount having a reflector formed as an upper portion thereof is partially removed by an etching, and having an electrode at an upper surface thereof;
a light emitting device arranged at one side of the upper surface of the sub mount so that light backwardly emitted therefrom is towards the reflector; and
a multi-divide photodiode arranged at another side of the upper surface of the sub mount and positioned at a portion where light backwardly emitted from the light emitting device and reflected by the reflector passes,
wherein the light emitting device arranged at one side of the upper surface of the sub mount is placed at a position lower than a position of the multi-divide photodiode arranged at another side of the upper surface of the sub mount.

2. The optical pickup module of claim 1, wherein the multi-divide photodiode is arranged at a position where light backwardly emitted from the light emitting device passes.

3. The optical pickup module of claim 1, wherein the multi-divide photodiode is formed as a rectangular hexahedron shape, and a sensing unit for sensing light backwardly emitted from the light emitting device is formed at a bottom surface having a relatively wide area among several surfaces of the multi-division photodiode.

4. The optical pickup module of claim 1, wherein the light emitting device and the multi-divide photodiode are together formed on the same plane.

5. The optical pickup module of claim 1, wherein the sub mount is composed of:
a silicon substrate formed as a partial region of the sub mount is etched as much as an angle of 40°-60°;
an insulating layer formed at an upper portion of the silicon substrate;
a reflector formed on the insulating layer of the region etched as much as an angle of 40°-60°; and
external electrodes electrically connected to electrodes of the light emitting device and the multi-divide photodiode.
